(19) United States
(12) Patent Application Publication
(10) Pub. No.: US 2025/0104668 A1
(43) Pub. Date: Mar. 27, 2025

(54) Image Compensation for Extreme Ambient Light Conditions

(71) Applicant: Apple Inc., Cupertino, CA (US)

(72) Inventors: Pradeep Nagesh, Irvine, CA (US); Mahesh B Chappalli, San Jose, CA (US); Alexey Kornienko, Watford (GB)

(21) Appl. No.: 18/474,957

(22) Filed: Sep. 26, 2023

(51) Int. Cl. G09G 5/06; G09G 3/20

(52) U.S. Cl. CPC G09G 5/06; G09G 3/2003; G09G 2320/0233; G09G 2320/0626; G09G 2320/0666; G09G 2340/06; G09G 2360/144

(57) ABSTRACT

Systems and techniques described herein may correct for chromatic deviations due to ambient dependent color perception in low-light conditions and/or bright-light conditions. Processing circuitry may determine a first and a second strength parameter based on an ambient brightness value, an intended display brightness value, one or more vectors, and a two-dimensional look up table. If the first strength parameter is greater than zero, then the processing circuitry may apply chromatic corrections based on luminance and chrominance compensation functions in an opponent color space. For example, per-pixel gains may be determined based on global curves and applied as a function of pixel value (e.g., luminance component). If the first strength parameter is less than zero and the second strength parameter is greater than zero, the processing circuitry may determine chromatic corrections based on a three-dimensional lookup table that may be programmable based on a strength parameter and/or a gain value.

### BACKGROUND

The disclosure relates generally to chromatic correction on a display panel, particularly under very dark or very bright ambient light conditions.

Electronic displays may be found in numerous electronic devices, from mobile phones to computers, televisions, automobile dashboards, and augmented reality or virtual reality glasses, to name just a few. In certain electronic display devices, light-emitting diodes such as organic light-emitting diodes (OLEDs), micro-OLEDs (μOLEDs), or active matrix organic light-emitting diodes (AMOLEDs) may be employed as display pixels to emit light and depict a range of colors for display. A viewer's eyes may integrate light from the electronic display to view image content. However, in extremely low-light conditions, retinal response degrades due to rod intrusion, which may lead to a perceived loss of color, contrast, and/or color details in the image content. Additionally or alternatively, in extremely bright-light conditions, interference from external (e.g., ambient) light along with bright human visual system adaptations result in a perceived shrinkage of the color gamut (e.g., range) in the image content. In both the extremely low-light conditions and the extremely bright-light conditions, the image content may be perceived by the viewer with deviations from a target image content (e.g., as programmed into the display pixels by image data). As such, systems and techniques for chromatic corrections are desired.

### SUMMARY

A summary of certain embodiments disclosed herein is set forth below. It should be understood that these aspects are presented to provide the reader with a brief summary of these certain embodiments and that these aspects are not intended to limit the scope of this disclosure. Indeed, this disclosure may encompass a variety of aspects that may not be set forth below.

Electronic devices often use electronic displays (e.g., OLED displays) to present visual information, such as image content. The electronic display may include light-modulating pixels, which may be light-emitting in the case of light-emitting diodes (LEDs) but may selectively provide light from another light source in other types of electronic displays. While this disclosure generally relates to self-emission displays, it should be appreciated that the systems and techniques of this disclosure may also apply to other forms of electronic displays and should not be limited to self-emissive displays. To display a frame of image content, the electronic display may control a gray level (e.g., luminance) of its display pixels based on image data received at a particular resolution. For example, an image data source may provide image data as a stream of pixel data, in which data for each pixel indicates a target luminance (e.g., brightness) and/or a target chrominance of one or more display pixels located at corresponding pixel positions. In an embodiment, image data may indicate gray level (e.g., corresponding to luminance) per color component, for example, via red component image data, blue component image data, and green component image data, collectively referred to as red, green, and blue (RGB) image data. Additionally or alternatively, the image data may be indicated by a luma channel, a gray scale, or other color basis.

The present disclosure relates to providing compensation for perceived chromatic deviations (e.g., variations) in low-light conditions and/or bright-light conditions due to ambient-dependent color perception. In low-light conditions, a viewer's eyes may operate using mesopic vision with both rod and cone photoreceptors to perceive light from the electronic display. The rods are responsible for vision in low-light conditions and for processing shapes, movement, and objects in peripheral vision. The cones are responsible for vision in bright-light conditions and for processing colors. However, in certain low-light conditions, the rods may interfere with color processing leading to a phenomenon known as rod intrusion. As such, the viewer may perceive the image content with decreased (e.g., loss of) color contrast, brightness, and/or color saturation along with a hue shift in comparison to reference light conditions, such as nominal indoor ambient light conditions, light conditions outside on a cloudy day, and/or particular light-conditions not in mesopic range. Additionally or alternatively, in bright-light conditions, interactions between external light photons and the electronic display may cause a perceived loss in the color gamut, such as a perceived loss in visibility and color saturation of the image content, in comparison to reference light conditions.

Systems and techniques that compensate for perceived chromatic deviations may substantially improve the visual appearance of the electronic display, such as the image content displayed. For example, the electronic device may include a chromatic correction (CC) block that restores perceptual consistency across non-reference ambient viewing conditions by compensating for color perception degradation (e.g., chromatic deviation), such as a perceived loss of color, brightness, contrast, and/or saturation of the image content. In low-light conditions, the CC block may provide global tone mapping to boost gray levels, chromatic corrections to boost color saturation, and corrections for hue shifts. For example, the CC block may receive image data, convert the image data from a first color space to an opponent (OPP) color space, adjust the image data in the OPP color space, and convert the image data from the OPP color space back to the first color space. The compensation may be determined based on one or more look-up tables storing compensation values in the OPP color space. The compensation may adjust a luminance and/or chrominance of the image data. In bright-light conditions, the CC block may restore contrast by local tone mapping and color saturation. To this end, the CC block may receive the image data and convert the image data from a first color space to a second color space, such as an image processing transform (IPT) color space. The CC block may apply compensation to the image data in the IPT color space and convert the image data back to the first color space. The compensation may be determined based on a three-dimensional (3D) look-up (LUT) table with equal or non-equal spacing. The compensation may increase a saturation of the image data. As such, the viewer may perceive the image content in low-light or bright-light conditions with chromatic colors that are the same or similar to reference light conditions.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a schematic block diagram of an electronic device, in accordance with an embodiment;

FIG. 2 is a perspective view of a watch representing an embodiment of the electronic device of FIG. 1, in accordance with an embodiment;

FIG. 3 is a front view of a tablet device representing an embodiment of the electronic device of FIG. 1, in accordance with an embodiment;

FIG. 4 is a front view of a computer representing an embodiment of the electronic device of FIG. 1, in accordance with an embodiment;

FIG. 5 is a circuit diagram of the display of the electronic device of FIG. 1, in accordance with an embodiment;

FIG. 6 is an example of the electronic device of FIG. 1 in the form of a desktop computer, in accordance with an embodiment;

FIG. 7 is a schematic illustration of image content being viewed in reference light conditions and image content being viewed in low-light conditions with and without chromatic corrections, in accordance with an embodiment;

FIG. 8 is a schematic illustration of image content being viewed in reference light conditions and image content being viewed in bright-light conditions with and without chromatic corrections, in accordance with an embodiment;

FIG. 9 is a block diagram of the electronic device of FIG. 1 including image processing circuitry that receives source image data and applies compensation to provide for chromatic corrections, in accordance with an embodiment;

FIG. 10 is a flowchart of an example method of the image processing circuitry of the electronic device of FIG. 1 applying compensation to the source image data to generate compensated image data, in accordance with an embodiment;

FIG. 11 is a block diagram of the image processing circuitry of the electronic device of FIG. 1 associated with providing chromatic corrections to compensate for ambient dependent color perception, in accordance with an embodiment;

FIG. 12 is a schematic diagram of the image processing circuitry of the electronic device of FIG. 1 determining one or more strength parameters for chromatic corrections, in accordance with an embodiment;

FIG. 13A is a graph of a first one-dimensional lookup table that provides a gain to boost pixel values associated with a first component of a pixel triplet, in accordance with an embodiment;

FIG. 13B is a graph of a second one-dimensional lookup table that provides a gain to boost pixel values associated with a second component of a pixel triplet, in accordance with an embodiment;

FIG. 13C is a graph of a third one-dimensional lookup table that provides a gain to boost pixel values associated with a third component of a pixel triplet, in accordance with an embodiment;

FIG. 14 is a graph of luminance curves in low-light conditions based on the first component, in accordance with an embodiment;

FIG. 15 is a flowchart of an example method of the image processing circuitry of the electronic device of FIG. 1 determining and applying compensation to image data to generate compensated image data in low-light conditions, in accordance with an embodiment;

FIG. 16 is a flowchart of an example method of the image processing circuitry of the electronic device of FIG. 1 determining and applying compensation to image data to generate compensated image data in low-light conditions, in accordance with an embodiment;

FIG. 17 is a schematic diagram of a three-dimensional lookup table that provides a gain to boost pixel values, in accordance with an embodiment; and

FIG. 18 is a flowchart of an example method of the image processing circuitry of the electronic device of FIG. 1 determining and applying compensation to image data to generate compensated image data in bright-light conditions, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

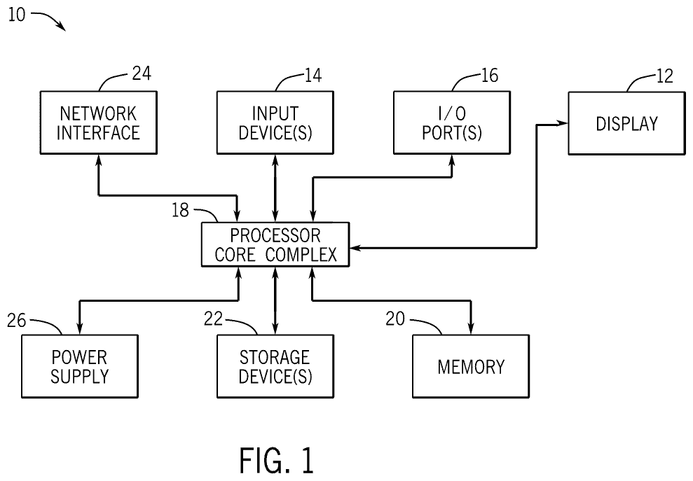

With the preceding in mind and to help illustrate, an electronic device 10 including an electronic display 12 is shown in FIG. 1. As is described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is one example of a particular implementation and is intended to illustrate the types of components that may be present in an electronic device 10.

The electronic device 10 includes the electronic display 12, one or more input devices 14, one or more input/output (I/O) ports 16, a processor core complex 18 having one or more processing circuitry(s) or processing circuitry cores, local memory 20, a main memory storage device 22, a network interface 24, a power source 26 (e.g., power supply), and an eye tracker 28. The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors, one or more application specific integrated circuits (ASICs), one or more field programmable logic arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network. The power source 26 may provide electrical power to one or more components in the electronic device 10, such as the processor core complex 18 or the electronic display 12. Thus, the power source 26 may include any suitable source of energy, such as a rechargeable lithium polymer (Li-poly) battery or an alternating current (AC) power converter. The I/O ports 16 may enable the electronic device 10 to interface with other electronic devices. For example, when a portable storage device is connected, the I/O port 16 may enable the processor core complex 18 to communicate data with the portable storage device.

The input devices 14 may enable user interaction with the electronic device 10, for example, by receiving user inputs via a button, a keyboard, a mouse, a trackpad, or the like. The input device 14 may include touch-sensing components in the electronic display 12. The touch sensing components may receive user inputs by detecting occurrence or position of an object touching the surface of the electronic display 12.

In addition to enabling user inputs, the electronic display 12 may include a display panel with one or more display pixels. The electronic display 12 may control light emission from the display pixels to present visual representations of information, such as a graphical user interface (GUI) of an operating system, an application interface, a still image, or video content, by displaying frames of image data. To display images, the electronic display 12 may include display pixels implemented on the display panel. The display pixels may represent sub-pixels that each control a luminance value of one color component (e.g., red, green, or blue for an RGB pixel arrangement or red, green, blue, or white for an RGBW arrangement).

The electronic display 12 may display an image by controlling light emission from its display pixels based on pixel or image data associated with corresponding image pixels (e.g., points) in the image. In some embodiments, pixel or image data may be generated by an image source, such as the processor core complex 18, a graphics processing unit (GPU), or an image sensor. Additionally, in some embodiments, image data may be received from another electronic device 10, for example, via the network interface 24 and/or an I/O port 16. Similarly, the electronic display 12 may display frames based on pixel or image data generated by the processor core complex 18, or the electronic display 12 may display frames based on pixel or image data received via the network interface 24, an input device, or an I/O port 16.

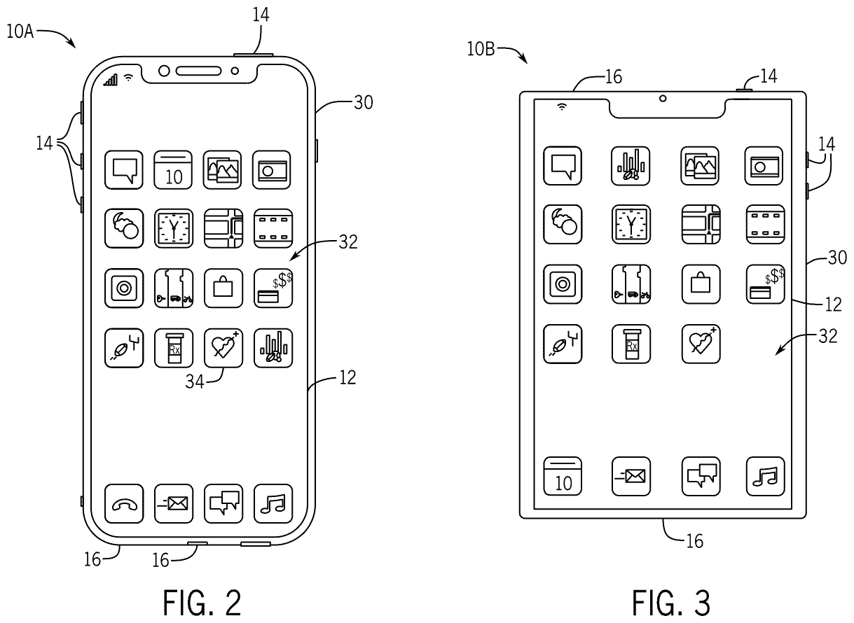

The electronic device 10 may be any suitable electronic device. To help illustrate, an example of the electronic device 10, a handheld device 10A, is shown in FIG. 2. The handheld device 10A may be a portable phone, a media player, a personal data organizer, a handheld game platform, or the like. For illustrative purposes, the handheld device 10A may be a smartphone, such as an iPhone® model available from Apple Inc.

The handheld device 10A includes an enclosure 30 (e.g., housing). The enclosure 30 may protect interior components from physical damage or shield them from electromagnetic interference, such as by surrounding the electronic display 12. The electronic display 12 may display a graphical user interface (GUI) 32 having an array of icons. When an icon 34 is selected either by an input device 14 or a touch-sensing component of the electronic display 12, an application program may launch.

The input devices 14 may be accessed through openings in the enclosure 30. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, or toggle between vibrate and ring modes.

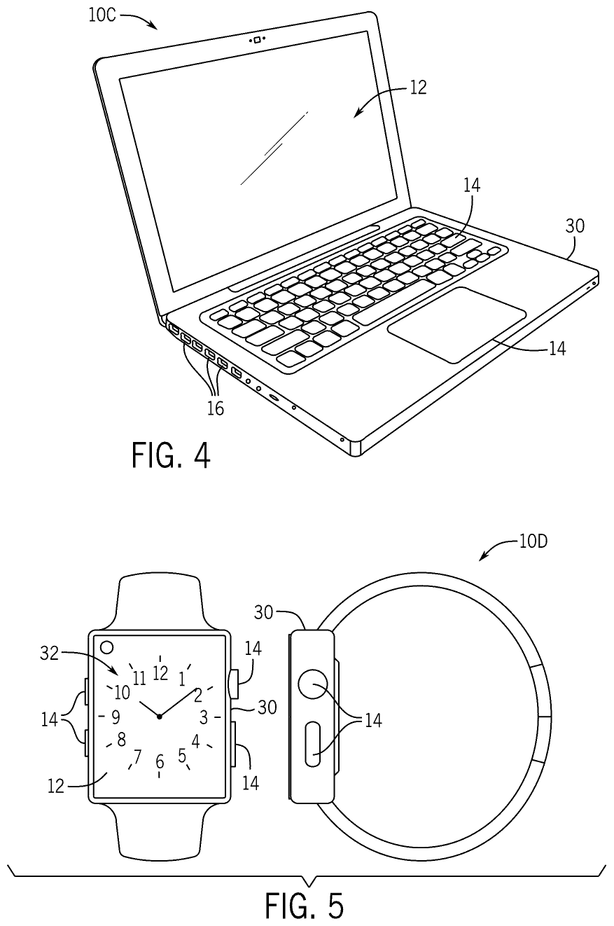

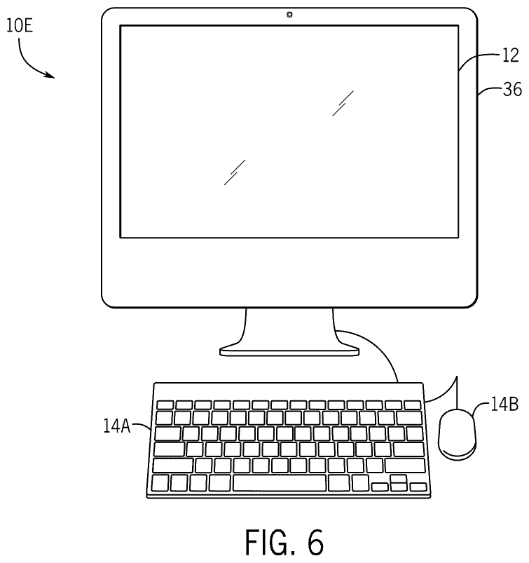

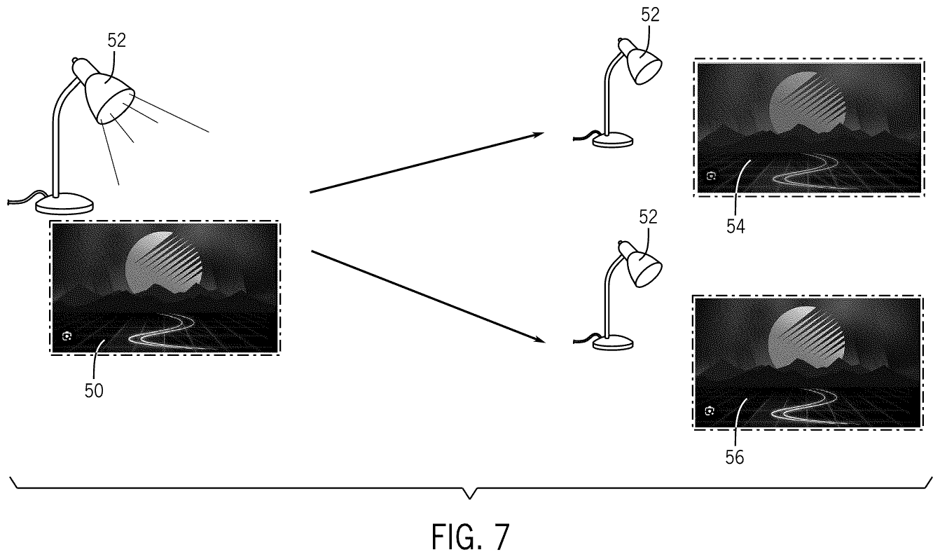

Another example of a suitable electronic device 10, specifically a tablet device 10B, is shown in FIG. 3. The tablet device 10B may be any iPad® model available from Apple Inc. A further example of a suitable electronic device 10, specifically a computer 10C, is shown in FIG. 4. For illustrative purposes, the computer 10C may be any MacBook® or iMac® model available from Apple Inc. Another example of a suitable electronic device 10, specifically a watch 10D, is shown in FIG. 5. For illustrative purposes, the watch 10D may be any Apple Watch® model available from Apple Inc. As depicted, the tablet device 10B, the computer 10C, and the watch 10D each also includes an electronic display 12, input devices 14, I/O ports 16, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons 34 discussed in FIGS. 2 and 3.

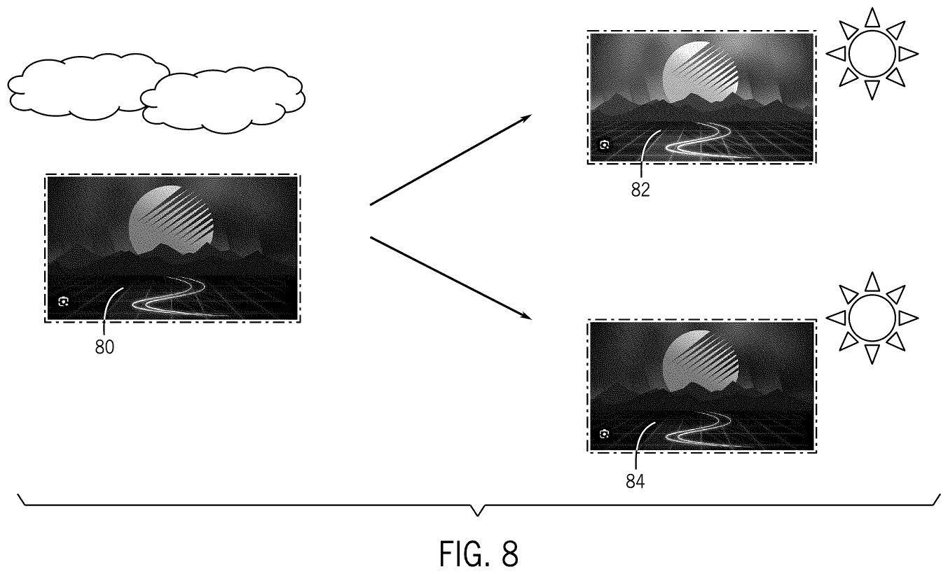

Turning to FIG. 6, a computer 10E may represent another embodiment of the electronic device 10 of FIG. 1. The computer 10E may be any suitable computer, such as a desktop computer, a server, or a notebook computer, but may also be a standalone media player or video gaming machine. By way of example, the computer 10E may be an iMac®, a MacBook®, or other similar devices by Apple Inc. of Cupertino, California. It should be noted that the computer 10E may also represent a personal computer (PC) by another manufacturer. A similar enclosure 36 may be provided to protect and enclose internal components of the computer 10E, such as the electronic display 12. In certain embodiments, a user of the computer 10E may interact with the computer 10E using various peripheral input device(s) 14, such as the keyboard 14A or mouse 14B (e.g., input devices 14), which may connect to the computer 10E.

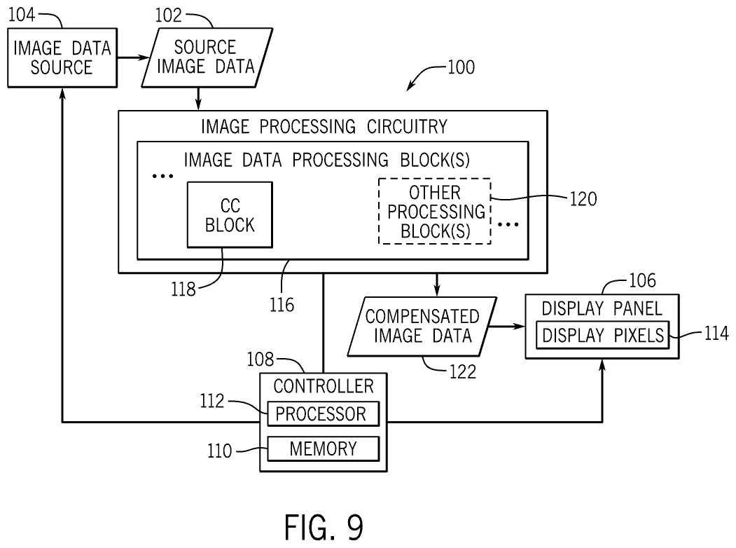

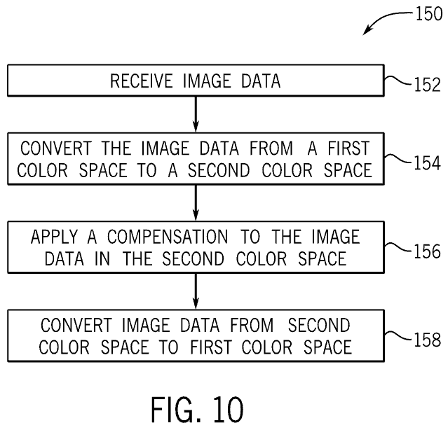

In some cases, the image content displayed by the electronic display 12 may be perceived by the viewer with loss of color contrast, brightness, color saturation, and/or visibility. In other words, the image content may be perceived with deviations from a target image content (e.g., as programmed into the display pixels by image data). Such deviations may be corrected, as depicted in FIGS. 7 and 8. Without chromatic corrections, the viewer may perceive the image content on the electronic display 12 with color deviations. However, after chromatic corrections, the viewer may perceive the image content with chromatic colors that are the same or similar to standard light conditions.

With the foregoing in mind, FIG. 7 illustrates image content 50 being viewed in reference light conditions and image content being viewed in low-light conditions with and without chromatic corrections. For example, reference light conditions may drop to low-light conditions when an external light source, such as a lamp 52, is turned off. As used herein, the low-light conditions may refer to light conditions above 0.01 lux and less than the order of 10-20 lux. In low-light conditions, the human visual system operates with mesopic vision in which both rod and cone photoreceptors tightly interact. However, the rod interferes with color vision resulting in the image content 54 being perceived with reduced color contrast, color brightness, and/or details. Additionally or alternatively, the image content 54 may be perceived with a hue-shift in comparison to the target image content. After providing for chromatic corrections, however, image content 56 in the low-light conditions may be perceived to be the same or similar to image content 50 in reference light conditions. In other words, the image content 56 in low-light conditions may be perceived with same or similar chromatic colors as the image content 50 in reference light conditions after the chromatic corrections. As such, the chromatic corrections may reduce or eliminate perceived chromatic deviations caused by rod intrusion.

FIG. 8 illustrates image content 80 being viewed in reference light conditions and image content being viewed in bright-light conditions with and without chromatic corrections. For example, image content 80 may be viewed outdoors on an overcast day (e.g., 100 to 5,000 lux), which may correspond to standard-light conditions. As such, the image content 80 may be perceived to be the same or similar to the target image content. However, light conditions outdoors may change from reference light conditions to bright-light conditions due to environmental factors, such as due to clouds moving or weather changing. As used herein, bright-light conditions may refer to light conditions greater than 5,000 lux, such as in outdoor ambient light conditions.

In the bright-light conditions, ambient light (e.g., light from the environment) may dominate the amount of light perceived by the viewer's eyes and cause the image content 82 to appear washed out (e.g., bleached out). In other words, the image content 82 may be perceived in the bright-light conditions with a reduced color gamut without chromatic corrections. However, after chromatic corrections, the image content 84 may be perceived with chromatic colors that are the same or similar to chromatic colors of the image content 80. As such, the chromatic corrections may reduce or eliminate perceived chromatic deviations caused by interference from external light.

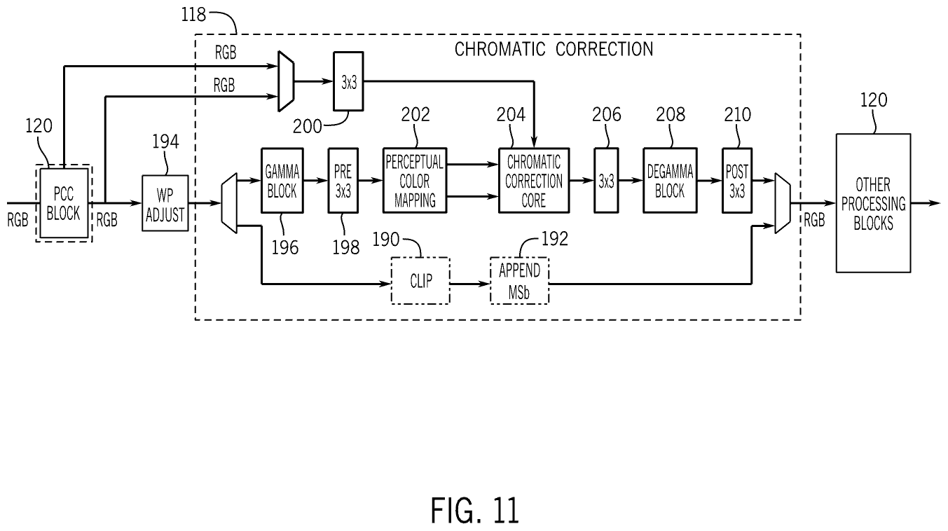

FIG. 9 is a block diagram of the electronic device 10 including image processing circuitry 100 that may receive source image data 102 and apply compensation to the source image data 102 to provide for chromatic corrections. The image processing circuitry 100 may be implemented in the electronic device 10, in the electronic display 12, or a combination thereof. For example, the image processing circuitry 100 may be included in the processor core complex 18, image processing circuitry, and the like. As should be appreciated, although image processing is discussed herein as being performed via a number of image data processing blocks, embodiments may include general purpose and/or dedicated hardware or software components to carry out the techniques discussed herein.

The electronic device 10 may include an image data source 104, a display panel 106, and/or a controller 108 in communication with the image processing circuitry 100. In some embodiments, the display panel 106 may include a reflective technology display, a liquid crystal display (LCD), or any other suitable type of display panel 106. In some embodiments, the controller 108 may control operation of the image processing circuitry 100, the display panel 106, the image data source 104, or any combination thereof. Although depicted as a single controller 108, in other embodiments, one or more separate controllers 108 may be used to control the operation of the image data source 104, the image processing circuitry 100, the display panel 106, or any combination thereof.

To control operation, the controller 108 may include one or more controller processors and/or controller memory 110. In some embodiments, the controller processor 112 may be included in the processor core complex 18, the image processing circuitry 100, a timing controller (TCON) in the electronic display 12, a separate processing module, or any combination thereof and execute instructions stored in the controller memory 110.

Generally, the image data source 104 may be implemented and/or operated to generate source (e.g., input or original) image data 102 corresponding with image content to be displayed on the display panel 106 of the electronic display 12. Thus, in some embodiments, the image data source 104 may be included in the processor core complex 18, a graphics processing unit (GPU), an image sensor (e.g., camera), and/or the like. Additionally, in some embodiments, the source image data 102 may be stored in the electronic device 10 before supply to the image processing circuitry 100, for example, in memory 20, a storage device 22, and/or a separate, tangible, non-transitory computer-readable medium.

As illustrated in FIG. 9, the display panel 106 may include one or more display pixels 114, which each include one or more color component sub-pixels. For example, each display pixel 114 implemented on the display panel 106 may include a red sub-pixel, a blue sub-pixel, and a green sub-pixel. In some embodiments, one or more display pixels 114 on the display panel 106 may additionally or alternatively include a white sub-pixel. The electronic display 12 may display image content on its display panel 106 by appropriately controlling light emission from display pixels (e.g., color component sub-pixels) 114 implemented thereon. Generally, light emission from a display pixel (e.g., color component sub-pixel) 114 may vary with the magnitude of electrical energy stored therein. For example, in some instances, a display pixel 114 may include a light-emissive element, such as an organic light-emitting diode (OLED), that varies its light emission with current flow there through, a current control switching device (e.g., transistor) coupled between the light-emissive element and a pixel power (e.g., VDD) supply rail, and a storage capacitor coupled to a control (e.g., gate) terminal of the current control switching device. As such, varying the amount of energy stored in the storage capacitor may vary the voltage applied to the control terminal of the current control switching device and, thus, the magnitude of electrical current supplied from the pixel power supply rail to the light-emissive element of the display pixel 114.

However, it should be appreciated that discussions with regard to OLED examples are intended to be illustrative and not limiting. In other words, the techniques described in the present disclosure may be applied to and/or adapted for other types of electronic displays 12, such as a liquid crystal display (LCD) 12, a digital micromirror device (DMD), and/or a micro light-emitting diode (LED) electronic display 12. In any case, since light emission from the display pixels 114 generally varies with electrical energy storage therein, to display an image, the electronic display 12 may write a display pixel 114 at least in part by supplying an analog electrical (e.g., voltage and/or current) signal to the display pixels 114, for example, to charge and/or discharge a storage capacitor in the display pixels 114.

To selectively write to the display pixels 114, as in the depicted example, the electronic display 12 may include driver circuitry, which includes a scan driver and a data driver. In particular, the electronic display 12 may be implemented such that each of its display pixels 114 is coupled to the scan driver via a corresponding scan line and to the data driver via a corresponding data line. Thus, to write a row of display pixels 114, the scan driver may output an activation (e.g., logic high) control signal to a corresponding scan line that causes each display pixel 114 coupled to the scan line to electrically couple its storage capacitor to a corresponding data line. Additionally, the data driver may output an analog electrical signal to each data line coupled to an activated display pixel 114 to control the amount of electrical energy stored in the display pixel 114 and, thus, control the resulting light emission (e.g., perceived luminance and/or perceived brightness).

As described above, source image data 102 corresponding with image content may indicate target visual characteristics (e.g., luminance and/or chrominance) at one or more specific points (e.g., image pixels) in the image content, for example, by indicating color component brightness (e.g., grayscale) levels that are scaled by a panel brightness setting. In other words, the source image data 102 may correspond with a pixel position on the display panel 106 and, thus, indicate the target luminance of at least a display pixel 114 implemented at the pixel position. For example, the source image data 102 may include red component image data indicative of the target luminance of a red sub-pixel in the display pixels 114, blue component image data indicative of the target luminance of a blue sub-pixel in the display pixels 114, green component image data indicative of the target luminance of a green sub-pixel in the display pixels 114, white component image data indicative of the target luminance of a white sub-pixel in the display pixels 114, or any combination thereof. Additionally or alternatively, the source image data 102 may include pixel triplets corresponding to the display pixels 114. The pixel triplet (c₀, c₁, c₂) may include the c₀ component corresponding to luminance, and the c₁ and c₂ components corresponding to chrominance. To display image content, the image data may be converted to gray levels corresponding to a relative brightness with respect to a global brightness value (e.g., with respect to a display brightness value (DBV)). The electronic display 12 may control the supply (e.g., magnitude and/or duration) of electrical signals from its data driver to the display pixels 114 based at least in part on corresponding image data and the global brightness value.

To improve perceived image quality, the image processing circuitry 100 may be implemented and/or operated to process (e.g., adjust) image data before the image data is used to display a corresponding image on the electronic display 12. Thus, in some embodiments, the image processing circuitry 100 may be included in the processor core complex 18, a display pipeline (e.g., chip or integrated circuit device), a timing controller (TCON) in the electronic display 12, or any combination thereof. Additionally or alternatively, the image processing circuitry 100 may be implemented as a system-on-chip (SoC).

As in the depicted example, the image processing circuitry 100 may receive source image data 102 corresponding to a desired image (e.g., a frame of image content) to be displayed on the electronic display 12 from the image data source 104. The source image data 102 may indicate target characteristics (e.g., pixel data) corresponding to the desired image using any suitable source format (e.g., color space), such as an RGB format, an αRGB format, a YCbCr format, and/or the like. Moreover, the source image data 102 may be fixed or floating point and be of any suitable bit-depth. Furthermore, the source image data 102 may reside in a linear color space, a gamma-corrected color space, a gray level space, or any other suitable color space. As used herein, pixels or pixel data may refer to a grouping of sub-pixels (e.g., individual color component pixels such as red, green, and blue) or the sub-pixels themselves.

As described herein, the image processing circuitry 100 may operate to process the source image data 102 received from the image data source 104. The image data source 104 may include captured images from cameras, images stored in memory, graphics generated by the processor core complex 18, or a combination thereof. Additionally, the image processing circuitry 100 may include one or more sets of image data processing blocks 116 (e.g., circuitry, modules, or processing stages), such as a chromatic correction (CC) block 118. As should be appreciated, multiple other processing blocks 120 may also be incorporated into the image processing circuitry 100, such as a color management block, a dither block, a pixel contrast control (PCC) block, a burn-in compensation (BIC) block, a scaling/rotation block, a panel response correction (PRC) block, and the like, before and/or after the CC block 118. The image data processing blocks 116 may receive and process the source image data 102 and output compensated image data 122 in a format (e.g., color space, digital format and/or resolution) interpretable by the display panel 106. Further, the functions (e.g., operations) performed by the image processing circuitry 100 may be divided between various image data processing blocks 116, and, while the term “block” is used herein, there may or may not be a logical or physical separation between the image data processing blocks 116.

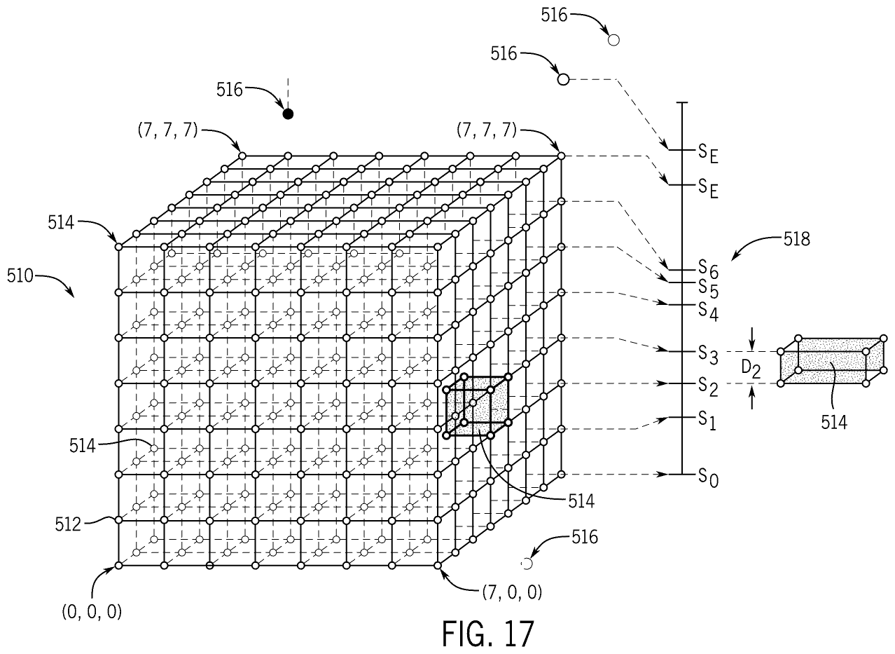

To compensate for chromatic deviations, the CC block 118 may determine and apply compensation (e.g., gain) to the source image data 102 to compensate for chromatic deviations. In other words, the CC block 118 may adjust the source image data 102 to generate the compensated image data 122. For example, the compensation may be one or more boosting gains to compensate for color contrast, saturation loss, hue-shift, and the like to generate the compensated image data 122. In low-light conditions, the CC block 118 may determine compensation based on one or more one-dimensional (1D) lookup tables (LUT) that incorporate both luminance and chrominance compensation functions in low-light conditions and adjust the image data based on the compensation. In bright-light conditions, the CC block 118 may determine compensation based on a three-dimensional (3D) LUT and adjust the image data based on the compensation. As further described with respect to FIG. 17, the 3D LUT may implement the chromatic corrections as an ambient brightness and color pixel dependent non-linear function. In certain low-light conditions, the CC block 118 may determine compensation based on both the 1D LUTs and the 3D LUTs. For example, the 1D LUT may provide a first compensation and the 3D LUTs may provide a second compensation that may fine-tune the first compensation. In this way, the CC block 118 may provide for chromatic corrections to compensate for ambient dependent color perception, which may provide for image content with chromatic colors that are the same or similar to image data viewed in reference light conditions.

Prior to adjusting the image data, the CC block 118 may convert the source image data 102 from a first color space to a second color space. In certain instances, the second color space may provide a larger color range in comparison to the first color space. The second color space may provide a perceptually more separated chrominance components and luminance component. The adjustment may be made in the second color space for a finer adjustment to the chrominance components. For example, the first color space may be a linear color space and the second color space may be a non-linear color space. The compensated image data 122 may be converted from the second color space back to the first color space and programmed into the display pixels 114 to display the image content. The compensated image data 122 may provide for image content with chromatic colors that are the same or similar to colors in reference light conditions. In this way, the CC block 118 may provide for chromatic corrections to compensate for ambient dependent color perception, which may provide for image content with chromatic colors that are the same or similar to image data viewed in reference light conditions.

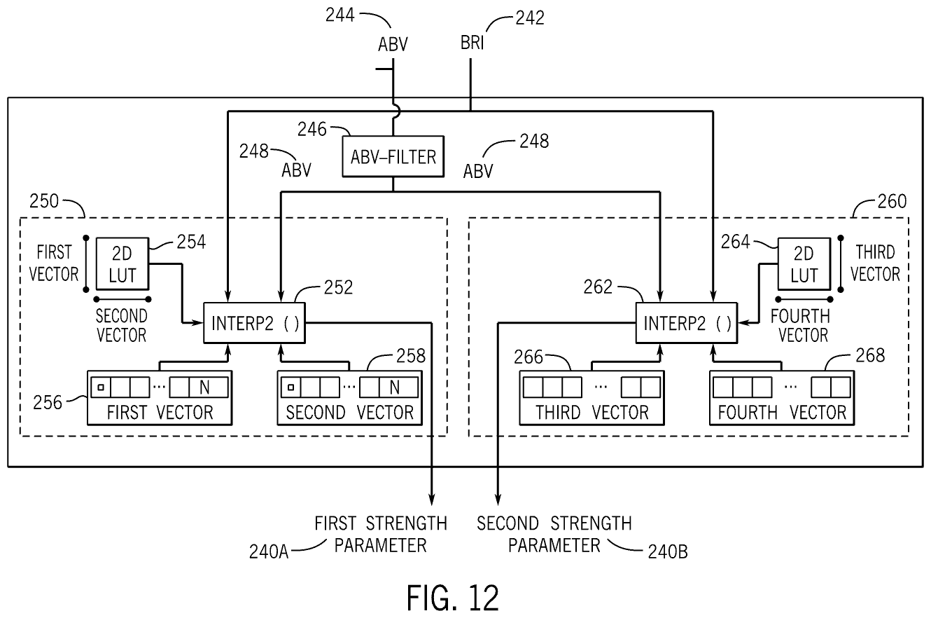

FIG. 10 is a flowchart of an example method 150 of image processing circuitry applying compensation to the source image data to generate the compensated image data. While the method of FIG. 10 is described using process blocks in a specific sequence, it should be understood that the present disclosure contemplates that the described process blocks may be performed in different sequences than the sequence illustrated, and certain described process blocks may be skipped or not performed altogether.

At block 152, the image processing circuitry (e.g., the processor core complex, image processing circuitry, image compensation circuitry) receives image data. The image data may correspond to a display pixel, one or more sub-pixels, and so on. In some embodiments, when the image processing circuitry receives the image data associated with an image from an image source, the image data may be in a first color space (e.g., format). For example, the image data may be received in the RGB color space.

At block 154, the image processing circuitry converts the image data from a first color space to a second color space. For example, the image processing circuitry may convert the source image data from a linear RGB color space to an opponent (OPP) color space such that a luminance component aligns with the luminance Y of an XYZ domain and chrominance components align with red-green (Crg) and blue-yellow (Cby) opponent hue angles. The conversion may be use one or more 3×3 transform matrices, such as from RGB color space to XYZ to OPP color space. The XYZ domain may be based on three imaginary primary colors that represent a standardized color space. The OPP color space may include a first component corresponding to red-green chrominance, a second component corresponding to blue-yellow chrominance, and a third component corresponding to a black-white chrominance and/or luminance. In another example, the image processing circuitry may convert the source image data from the RGB color space to a long, medium, short (LMS) color space and from the LMS color space to the IPT color space using a 3×3 transform. The LMS color space may represent a response of the three types of cones in the human visual system. In other words, the LMS color space may represent colors based on the sensitivity of the cones to different wavelengths of light. The IPT color space may include a first component corresponding to intensity and/or luminance, a second component corresponding to blue-yellow chrominance, and a third component corresponding to red-green chrominance. As such, in the second color space, the image data may be divided into a pixel triplet with a first component corresponding to luminance, a second component corresponding to chrominance, and a third component corresponding to chrominance.

At block 156, the image processing circuitry applies compensation to the image data in the second color space. In certain cases, the second color space provides a larger range of chromatic colors in comparison to the RGB color space. As such, applying compensation in the second color space may provide improved uniformity, color contrast, color differentiation, hues, and so on. For example, the image processing circuitry may determine one or more boosting gains based on a function of the luminance component in the second color space to compensate for chromatic deviations. The boosting gains may be realized as per-pixel gains. In another example, the image processing circuitry may determine the compensation based on the 3D LUT.

After applying the chromatic corrections described above, at block 158, the image processing circuitry converts the image data from the second color space to the first color space. For example, the image processing circuitry may convert the compensated image data from the OPP color space back to the RGB color space. The conversion may be performed with one or more 3×3 transform matrices. In another example, the image processing circuitry may convert the compensated image data from the IPT color space to the LMS color space and then to the RGB color space. The compensated image data may be used to drive the display pixels such that the image content is displayed with reduced or eliminated chromatic deviations due to ambient-dependent color perception. Additionally or alternatively, the compensated image data may be transmitted to other processing blocks and/or the display panel 106.

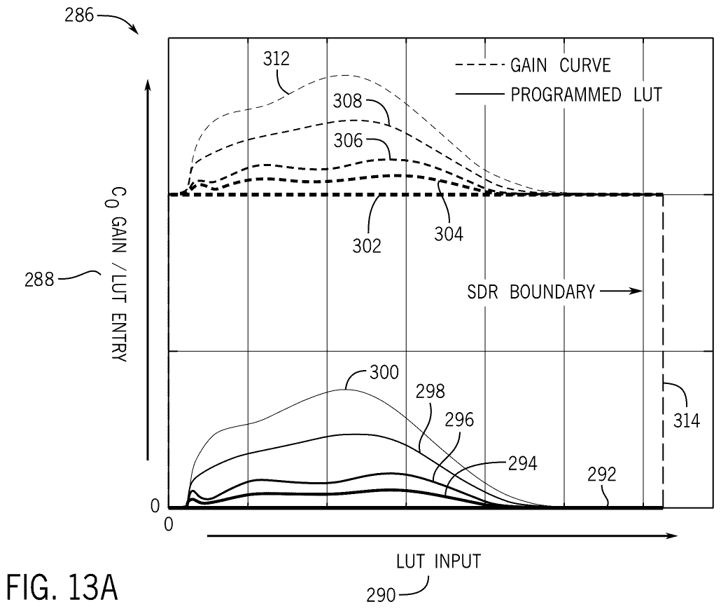

FIG. 11 is a block diagram of the image processing circuitry 100 associated with providing chromatic corrections to compensate for ambient-dependent color perception. In particular, the CC block 118 may operate on the source image data 102 to compensate for chromatic deviations based on certain conditions. For example, chromatic corrections may be applied in low-light conditions if a first strength parameter is greater than zero. Additionally or alternatively, chromatic corrections may be applied in bright-light conditions if a second strength parameter is greater than zero. In certain cases, both the first strength parameter and the second strength parameter may be less than zero, as such chromatic corrections may not be applied. For example, the CC block 118 may initialize a bypass mode and may not apply compensation to the source image data. In the bypass mode, the CC block 118 may, at clipping block 190, clip the source image data 102 and append, at the MSB block 192, a most significant bits (MSB) to the source image data 102.

The CC block 118 may convert the source image data 102 from a first color space to a second color space. For example, the CC block 118 may receive a signal indicative of a linear RGB pixel value that may be converted into a different color space, such as in gamma space or linear space. In particular, the CC block 118 may include a white point adjustment (WPA) block 194, a gamma block 196, and a pre-3×3 transform block 198 (referred to herein as “first conversion circuitry”) may receive the source image data 102 from other processing blocks 120, such as the PCC block, and convert the source image data 102 to a different color space. The WPA block 194 may support conversions from a first color space to a different color space through a 3×3 transform matrix (e.g., color conversion matrix). In certain cases, the PCC block may provide for local tone mapping prior to transmitting the source image data 102 to the WPA block 194. The local tone mapping may improve color saturation of the image data.

The gamma block 196 may implement a programmable LUT and interpolation logic to support non-linear gamma encoding of input linear pixels. The programmable LUT may include any suitable number of non-equally or equally spaced entries. For example, the programmable LUT may include 641 non-equally spaced entries spread across 19 sub-LUTs. Spacing within each respective sub-LUT may be different. When enabled, the gamma block 196 may receive an input signal (e.g., source image data 102), sign-neutralize the input signal, index within the LUT, and output one or more pixel triplets (c₀, c₁, c₂) corresponding to the input signal. In certain embodiments, the gamma block 196 may be disabled and the input signal may be copied to the output signal.

The pre-3×3 transform block 198 receives a pixel triplet and generates a pixel triplet output based on one or more input offsets, one or more output offsets, a 3×3 transform matrix, and output clips. Additionally or alternatively, the pre 3×3 transform block 198 may support 3×3 matrix multiplication, clip outputs, and so on. For example, the 3×3 matrix multiplication may include coefficients restricted to a pre-determined range and specified with a pre-determined precision. In certain instances, maximum and minimum clipping limits may be set to equal and opposite values to provide for a symmetric range of values. In this way, the CC block 118 may support various color spaces may such as IPT color space, Y′CbCr, LMS, XYZ, OPP color space, variants of opponent color space models (e.g., A (r/g), (by/)), and the like. In certain instances, the gamma block 196 and the pre-3×3 transform block 198 may operate together to convert the image data from the RGB color space to the OPP color space.

The CC block 118 may receive the source image data 102 from other processing blocks 120, such as a PCC block, modify a white point of the source image data 102 for adaptation to ambient light conditions, and convert the source image data 102 from the first color space to the second color space. To this end, the CC block 118 may include a 3×3 block 200 that includes a set of input offsets, a 3×3 matrix multiplication, and a set of output offsets. For example, the 3×3 transform block 200 may receive the source image data 102 and transform pixel values of the source image data 102 by multiplying the pixel values with one or more coefficients and adding the output to one or more offset values. Additionally or alternatively, the 3×3 transform block 200 may convert the source image data 102 from the first color space to the second color space.

In the second color space, the CC block 118 may determine and apply the compensation using a perceptual color mapping (PCM) block 202 and/or a chromatic correction core (CCC) block 204. The second color space may provide a larger chrominance range in comparison to the RGB color space, which may improve chromatic corrections. The PCM block 202 and/or the CCC block 204 may include one or more chromatic correction functions that individually or collectively realize flexible and complex color correction functions in either the gamma space or the linear space. For example, the PCM block 202 may apply compensation gains to individual pixel components that may vary from frame to frame depending on panel peak brightness and/or ambient brightness levels.

For example, the PCM block 202 may receive the image data and adjust the image data. For example, the PCM block 202 may adjust the image data when the display brightness value is below a first threshold. The first threshold may correspond to the luminance of low-light conditions such as 20 lux. The PCM block 202 may receive the pixel triplet (c₀, c₁, c₂) and output a boosted signal as a compensated pixel triplet (c′₀, c₁, c₂). As used herein, the first pixel component corresponds to c₀, the second pixel component corresponds to c₁, and the third pixel component corresponds to c₂. To boost the pixel triplet, the PCM block 202 may include one or more 1D LUTs with gain functions. In certain instances, the boosting gains for the pixel triplet may be determined based on the c₀ component while the c₁ component and the c₂ component pass through with one sign bit extension. In other instances, a first gain value may be determined for the c₀ component, a second gain value may be determined for the c₁ component, and/or a third gain value may be determined for the c₂ component. The gain determination for the c₁ and c₂ components may use a two-piece function. The two-piece function may include first portion corresponding to a standard dynamic range (SDR) and a second portion corresponding to a high dynamic range (HDR) and/or an extended dynamic range (EDR) For example, a gain function may be represented for an unsigned input range corresponding to SDR peak brightness. In this way, the PCM block 202 may provide for uniform chromatic appearance across varying ambient light conditions by providing compensation for perceived brightness and perceived color.

In an example, the CCC block 204 may receive the image data and adjust the image data. For example, the CCC block 204 may adjust the image data when the display brightness value is above a second threshold. The second threshold may correspond to luminance of the bright-light conditions such as 5000 lux. In other words, the first threshold and the second threshold are different. The CCC block 204 may include an RGB-indexed 3D LUT that may be programmable to realize complex gain functions for boosting pixel values. The CCC block 204 may receive the pixel triplet in either linear or gamma-encoded space and adjust the image data based on compensation from the 3D LUT. For example, the 3D LUT may include a first axis with a number of tap points, a second axis with a number of tap points, and a third axis with a number of tap points. Each axis may correspond to a pixel component and the compensation may be determined based on a combination of the three pixel components. In other words, the CCC block 204 may include a 3D function that provides for chromatic corrections as a chroma gain value instead of direct pixel values.

The CC block 118 may implement the PCM block 202, the CCC block 204, or both. For example, in low-light conditions, the PCM block 202 may adjust the image data while the CCC block 204 may adjust the image data in bright-light conditions. In another example, the PCM block 202 and the CCC block 204 may adjust the image data in the low-light conditions. To this end, the CCC block 204 may include an option of receiving the source image data 102 either from the input or the output of the other processing blocks 120. In certain cases, the CC block 118 may bypass the PCM block 202 such that the CCC block 204 determines the compensation based on the source image data 102 and the 3D LUT. In another example, both the PCM block 202 and the CCC block 204 may determine compensation for the source image data 102. In this case, the PCM block 202 may determine a first compensation based on the one or more 1D LUTs and the CCC block 204 may determine secondary fine-grained compensations based on the 3D LUT. The PCM block 202 and/or the CCC block 204 may boost pixel values to provide for an additional headroom of up to 4×.

The CC block 118 may also include one or more components to convert the output from the PCM block 202, the CCC block 204, or both from the second color space back to the first color space. For example, the first color space may be the RGB color space and CC block 118 may clip and/or soft clip negative pixel values to convert the compensated image data 122 to the RGB color space. In certain instances, the CC block 118 may soft-clip non-negative values to bring the pixel values into the RGB color space. For example, a second 3×3 transform block 206, a de-gamma block 208, and a post 3×3 transform block 210 may convert the compensated image data (referred to herein as “second conversion circuitry”).

The second 3×3 transform block 206 receives the compensated pixel triplet and produces a pixel triplet output. The second 3×3 transform block 206 includes one or more input offsets, output offsets, a 3×3 matrix, and output clip limits. In certain embodiments, the second 3×3 transform block 206 may include coefficients that are inverse (e.g., opposite) of the coefficients of the first 3×3 transform block 200. In this way, the post-color manager may convert the compensated image data 122 from the second color space to the first color space.

The de-gamma block 208 implements one or more programmable LUTs and interpolation logic to provide for non-linear gamma to linear-space conversion of the compensated pixel triplet to gamma space pixels of the same precision. To this end, the de-gamma block 208 may include a first LUT with 512 entries that may be equally spaced, a second LUT with 16 entries that may be equally spaced, and a third LUT with 16 entries that may be equally spaced. The first LUT may cover a range from 0 to 2²⁶ and the second LUT and/or the third LUT may extend the range beyond 2²⁶. As such, the first LUT, the second LUT, and/or the third LUT may be treated as one programmable LUT with 545 non-equally spaced entries. For example, the de-gamma block 208 may receive the compensated pixel triplet, index the LUT based on the compensated pixel triplet, and output a pixel triplet. In certain instances, negative values outputted from the de-gamma block 208 may be clipped to 0 at the post 3×3 transform block 210. Clipping the pixel triplet may maintain a 4× boosting headroom, which may improve chromatic corrections.

The post 3×3 transform block 210 may receive the compensated pixel triplet input and produce output a pixel triplet with an extended range (e.g., 4× headroom). To this end, the post 3×3 transform block 210 may include one or more input offsets, one or more output offsets, a 3×3 matrix, and output clip limits. As illustrated, the compensated image data 122 may be transmitted to the other processing blocks 120. In certain instances, the compensated image data 122 may be programmed into the display panel 106 to produce image content with reduced or eliminated chromatic deviations due to ambient dependent color perception.

In low-light conditions, additional headroom may be used for the compensated pixel values to preserve contrast for certain colors at the end of the color range. As such, the post 3×3 transform block 210 may apply a boosting factor to preserve the headroom. The boosting factor may be determined based on coefficients for an Nth order polynomial defining the shape of a boost profile as a function of SDR reference white brightness, a low and a high SDR white brightness level, a maximum EDR headroom for the type of electronic display 12, and/or one or more weighting functions. The weighting functions may modulate the boost factor as a function of EDR headroom. In certain instances, the weighting function may taper from 1.0 to 0 for an EDR headroom ranging from 1 to a maximum EDR headroom.

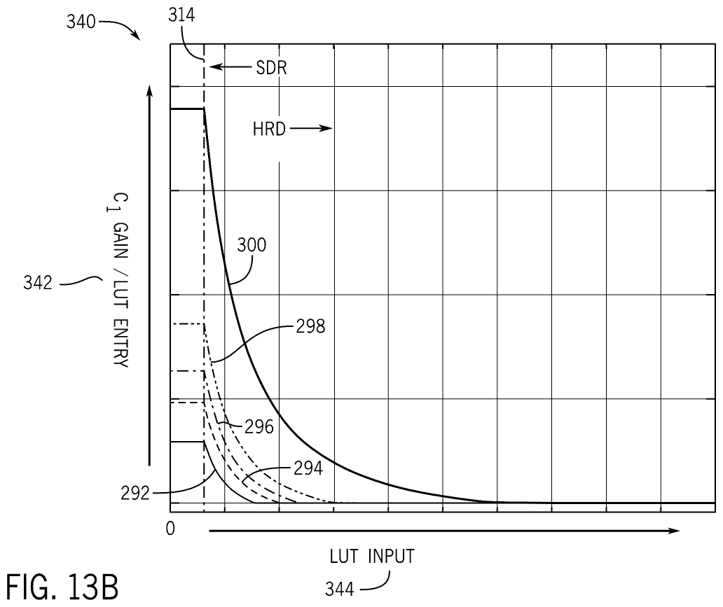

FIG. 12 is a schematic diagram of the image processing circuitry 100 determining one or more strength parameters 240 for the chromatic corrections. For example, a first strength parameter 240A may be used to determine activation of chromatic corrections in the low-light conditions and a second strength parameter 240B may be used to determine activation in the bright-light conditions. Additionally or alternatively, the strength parameters 240 may be used to determine an amount of compensation applied to the source image data 102. For example, the strength parameters 240 may be determined and/or updated at an appropriate frequency to provide for a smooth front-of-screen temporal behavior. That is, implementation of the strength parameters 240 may reduce or eliminate perceivable chromatic deviations in the image content.

The strength parameters 240 may a function of intended display brightness (Bri_{SDR}) value 242 and ambient brightness value (ABV) 244. The ABV 244 may be determined by a sensor coupled to the electronic device 10. The Bri_{SDR} value 242 may be an intended SDR brightness value determined by the source image data 102. In certain cases, the ABV 244 may depend on the Bri_{SDR} value 242. Additionally or alternatively, the Bri_{SDR} value 242 and/or the ABV 244 may depend on display brightness, ambient light conditions, and so on. For example, the Bri_{SDR} value 242 and/or the ABV 244 may change during a brightness ramping triggered by changes in ABV, such as moving from indoors to outdoors, environmental factors, turning off a lamp, and the like. To reduce signal noise, an ABV filter 246 may receive the ABV 244 and modulate (e.g., smooth) the ABV 244. The ABV filter 246 include one or more ABV thresholds used to determine a magnitude of perturbations in the positive direction and/or negative direction, a ramp time for position and/or negative ABV perturbations, one or more polynomial coefficients, and/or a minimum update rate. For example, the ABV filter 246 may receive the ABV 244 at a native rate and smooth the ABV 244 in either a ramp mode or a hold mode to generate a smoothed ABV 248. The ramp mode may be triggered at a time=t if an ABV step is greater than a threshold. As such, a subsequent ABV may be generated with a decreased step based on a curvature path, a polynomial function, or the like. In the hold mode, the ABV filter 246 may receive the ABV 244 and output a previously smoothed ABV. As such, the strength parameter determination may include modulation of smoothing and/or facilitating the desired temporal front-of-screen behavior along with a steady-state response. In certain instances, the brightness ramping may cause the CC block 118 to ramp into applying the compensation or ramp out of applying the compensation.

From the ABV filter 246, the smoothed ABV 248 may be used to determine the first strength parameter 240A, the second strength parameter 240B, or both. At block 250, the smoothed ABV 248 may be used to determine the first strength parameter 240A for low-light conditions. The smoothed ABV 248 may be received by an interpolation block 252 that implements bi-linear interpolation to determine the first strength parameter 240A. The interpolation block 252 may also receive input from a two-dimensional (2D) LUT 254, a first vector 256, and/or a second vector 258. The first vector 256 may correspond to monotonically increasing ambient brightness floating point values to a first threshold (N). The values in the first vector 256 may be in units of lux. As an example, the first threshold may correspond to the upper threshold for the low-light conditions. For example, the upper threshold may be 100 nits. However, the upper threshold may be overridden by user input, product specification, such as a type of electronic device 10, and the like. The second vector 258 may correspond to monotonically increasing brightness floating values, in the unit of nits, with a second threshold (M). In certain instances, the second threshold may correspond with an activation threshold for activating chromatic corrections in low-light conditions. For example, the activation threshold may be 10 nits, however, it may be overridden. The 2D LUT 254 may include first dimensions and second dimensions respectively corresponding to sample points of the first vector 256 and the second vector 258. For example, each row vector may be based on sample points from the second vector 258 and/or each column vector may be based on sample points from the first vector 256. The row vectors and the column vectors may be monotonically non-increasing. In other words, the 2D LUT 254 may be indexed by the first vector 256 and the second vector 258. The interpolation block 252 may determine the first strength parameter 240A by indexing the 2D LUT 252 based on the Bri_{SDR} 242 and the ABV 244.

Additionally or alternatively, the first strength parameter 240A may be mapped to an intrinsic compensation parameter (L_{SDR-peak} parameter). The L_{SDR-peak} parameter may be determined based on the first strength parameter 240A, an activation threshold for low-light conditions, and a minimum supported brightness. The activation threshold may depend on the type of electronic device 10. For example, the activation threshold may be set to 10 nits unless overridden by user input, the type of electronic device, product specifications, and so on. The L_{SDR-peak} parameter may be used to compute tone and chroma compensation curve components which may correspond to an amount of adjustment applied to the image data for chromatic compensation. In a steady state, the first strength parameter 240A and a translation of the L_{SDR-peak} parameter may correlate to an SDR brightness value that may be intrinsically mapped to a commensurate compensation used in tone curve and chromatic correction components to counter perception loss from low-light conditions. It may be understood that such mapping may depend on the type of electronic device 10, the electronic display 12, the display panel 106, and the like.

At block 260, the smoothed ABV 248 may be used to determine the second strength parameter 240B for bright-light conditions. An interpolation block 262 may receive the smoothed ABV 248, a 2D LUT 264, a third vector 266, and a fourth vector 268 to determine the second strength parameter 240B. The third vector 266 may correspond to monotonically increasing ambient brightness floating point values, in the units of lux, to a third threshold. The third threshold may correspond to an activation threshold for chromatic corrections in the bright-light conditions. For example, the third threshold may be 5000 lux. However, the upper threshold may be overridden. The fourth vector 268 may correspond to monotonically increasing brightness floating point values, in the units of nits, with an upper threshold that corresponds to a maximum brightness of the electronic display 12. The maximum brightness may be determined based on the type of electronic display 12. The 2D LUT 264 may include first dimensions and second dimensions respectively corresponding to sample points of the third vector 266 and the fourth vector 268. For example, each row vector may be based on sample points from the fourth vector 268 and each column vector may be based on sample points from the third vector 266. The interpolation block 262 may determine the second strength parameter 240B by indexing the 2D LUT 262 based on the Bri_{SDR} 242 and the ABV 244.

With the foregoing in mind, chromatic corrections in low-light conditions may be activated if the first strength parameter is greater than zero. As discussed with respect to FIG. 11, the PCM block 202 may determine and apply compensation to the source image data 102 based on one or more 1D LUTs in the low-light conditions. In certain cases, the CCC block 204 may determine and apply an additional compensation in the low-light condition.

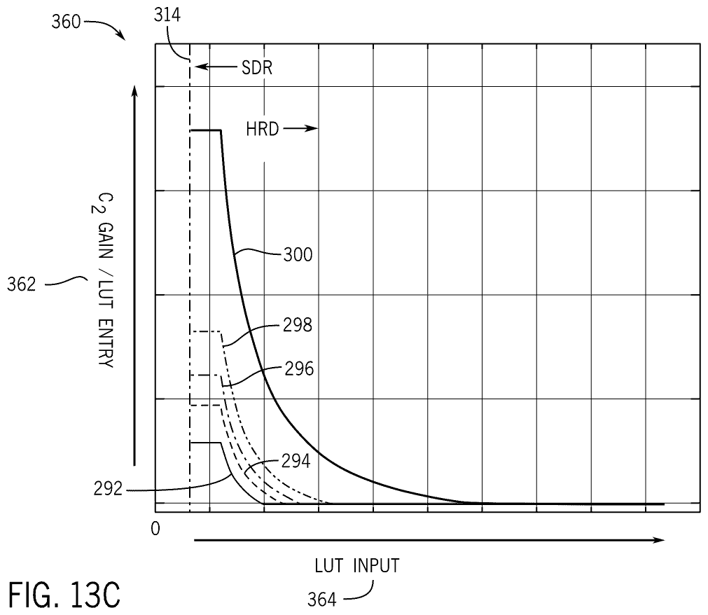

FIGS. 13A-C illustrate 1D LUTs for providing gain functions to boost original pixel values, such as from the source image data 102. The gain curves may be modulated as a function of an L_{SDR-peak} parameter for a current frame. The gain curves may remain fixed for varying HDR and/or EDR headroom if the L_{SDR-peak} parameter remains constant. Additionally or alternatively, the gain curves may be bound by an upper brightness value and a lower brightness value in nits. The upper brightness value and the lower brightness value may both be less than first threshold described with respect to FIG. 12.

As discussed herein, the PCM block 202 may receive a pixel triplet (c₀, c₁, c₂) either in a linear or a gamma-encoded space. The PCM block 202 may determine and apply the chromatic compensation in a linear-space operation on an opponent-color-model involving luminance (c₀) and chrominance (c₁, c₂) expressed as red-green and blue-yellow opposing colors. In particular, the PCM block 202 may apply compensation to the luminance component as described with respect to FIG. 13A and the PCM block 202 may apply compensation to the chrominance components as described with respect to FIGS. 13B and 13C.

With the foregoing in mind, FIG. 13A illustrates a graph 286 of a first 1D LUT to provide a gain 288 to boost pixels values associated with the first component 290 of the pixel triplet. As illustrated by the graph 286, the first component plane gain LUT curve is illustrated as a P-th order polynomial with two knee-points. The graph 286 illustrates a first line 292 corresponding to a red component, a second line 294 corresponding to a yellow component, a third line 296 corresponding to a green component, a fourth line 298 corresponding to a cyan component, and a fifth line 300 corresponding to a blue component. When the value of the first component 290 is less than the two knee-points, the output component may be the same as the first component 290. When the value of first component 290 is between the two knee-points, the output component may be a blend between the first component 290 and the P-th order polynomial. For example, the graph 286 illustrates a sixth line 302 corresponding to gain for the red component, a seventh line 304 corresponding to gain for the yellow component, an eighth line 306 corresponding to gain for the green component, a ninth line 308 corresponding to gain for the cyan component, and a tenth line 310 corresponding to gain for the blue component.

As illustrated, the first line 292, the second line 294, the third line 296, the fourth line 298, and the fifth line 300 are within an SDR boundary 314. The SDR boundary 314 may be determined based on the type of electronic device 10, device constraints, product specifications. For HDR and EDR ranges, the first 1D LUT may be extended by a ratio of 1:1 or using an identity transform. In other words, the final curves may provide for a gain output clipped to 1.0 at or before the first component 290 reaches the SDR boundary 314.

FIG. 13B illustrates a graph 340 of a second 1D LUT to provide gain 342 to boost pixel values associated with the second component 344 of the pixel triplet. The second 1D LUT may be a two-piece function. For example, a first piece may provide gains 342 within the SDR boundary 314 (e.g., left of the SDR boundary) and a second piece may provide for gains 342 outside of the SDR boundary 314 (e.g., right of the SDR boundary), such as for HDR and/or EDR. As illustrated by the first line 292, the second line 294, the third line 296, the fourth line 298 and the fifth line 300, the gain 342 may be constant within the SDR boundary 314, while the gain 342 is illustrated as a Q-th order polynomial outside of the SDR boundary 314. In other words, the gain 342 may roll off outside of the SDR boundary 314. The coefficients for the second 1D LUT may be fixed based on the type of electronic device 10.

FIG. 13C illustrates a graph 360 of a third 1D LUT to provide gain 362 to boost pixel values associated with the third component 364 of the pixel triplet. The third 1D LUT may be a two-piece function with the first piece providing gains 362 within the SDR boundary 314 and the second piece providing gains 362 outside of the SDR boundary. As illustrated, the gains 362 within the SDR boundary 314 may be constant while the gains 362 outside the SDR boundary 314 may be illustrated by a Q-th order polynomial.

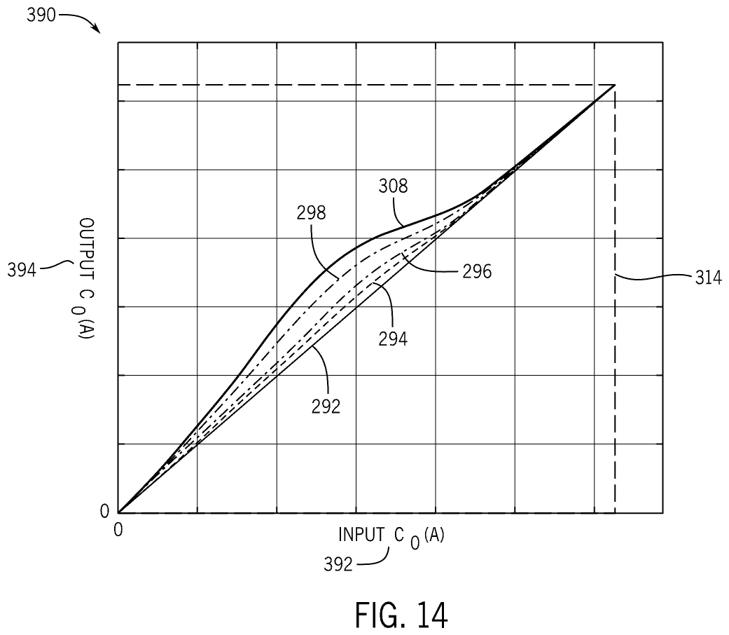

FIG. 14 illustrates a graph 390 of luminance curves (e.g., mapping) in low-light conditions based on the first component 392 of the pixel triplet. In particular, the graph 390 illustrates luminance 394 for a first component 392 of the pixel triplet. The luminance curves may include a first line 292 corresponding to a red component, a second line 294 corresponding to a yellow component, a third line 296 corresponding to a green component, a fourth line 298 corresponding to a cyan component, and a fifth line 300 corresponding to a blue component.

As illustrated by the graph 390, an input component of the pixel triplet (e.g., as output by the pre-3×3 transform block 198) may be used to determine an output component of the pixel triplet. The output component may be a boosted pixel value that produces image content with a perceived reduction in chromatic deviations. As illustrated by the lines 294-302, the first component 392 may correspond to any suitable color. Additionally or alternatively, the first component 392 of the pixel triplet may correspond to luminance 394. In certain cases, the first component 392 may not be boosted, such as illustrated by the first line 292. As such, the relationship between the first component 392 and the luminance 394 may be linear. In other cases, the first component 392 may be boosted. However, boosting the pixel triplet may increase the value, which may use additional headroom. If the first component 392 is fully saturated, the additional headroom may not be available for boosting the value. To provide for chromatic corrections, the luminance 394 may be increased to provide the additional headroom, such as illustrated in lines 296, 298, 300, and 302. In certain instances, the luminance 394 may be increased for a respective pixel value rather than overall luminance of the electronic device 10 to reduce overall power usage.

Furthermore, the luminance curves may be within the SDR boundary 314. In certain cases, HDR and/or EDR may include an expanded range in comparison to SDR. The expanded range may provide for the additional headroom used in boosting pixel values without increasing luminance. Additionally or alternatively, perceived chromatic deviations may be less visible in HDR and/or EDR as brightness levels may be higher than brightness levels in SDR. As such, luminance boosts may not be used in HDR and/or EDR, thereby reducing power used by the electronic device 10.

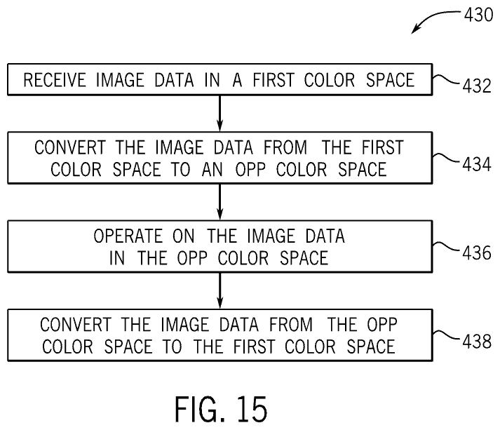

FIG. 15 is a flowchart of an example method 430 of the image processing circuitry determining and apply compensation to image data (e.g., source image data) to generate compensated image data in low-light conditions. While the method of FIG. 15 is described using process blocks in a specific sequence, it should be understood that the present disclosure contemplates that the described process blocks may be performed in different sequences than the sequence illustrated, and certain described process blocks may be skipped or not performed altogether.

At block 432, the image processing circuitry receives image data in a first color space. As discussed herein, the image processing circuitry may receive source image data from the image data source. In particular, the CC block 118 may receive the source image data from other processing blocks 120. The image data may be in any suitable color space (e.g., format), such as an RGB color space, an αRGB color space, a YCbCr color space, an LMS color space, an XYZ color space, an IPT color space, and the like.

At block 434, the image processing circuitry converts the image data from the first color space to an OPP color space. For example, the image processing circuitry may convert the source image data from a linear RGB color space to the OPP color space such that the luminance component aligns with the luminance Y of an XYZ color space and the chrominance component axis aligns with red-green (Crg) and blue-yellow (Cby) opponent hue angles. The conversion may be performed with one or more 3×3 transform matrices, such as from RGB to XYZ to OPP. For example, a first 3×3 transform matrix may be used to convert from RGB to XYZ and a second transform matrix may be used to convert from XYZ to OPP. In another example, one 3×3 transform matrix may be used to convert from RGB to OPP. The singular 3×3 transform matrix may be determined based on the first 3×3 transform matrix and the second 3×3 transform matrix. The conversion may account for the white point value (D65) and maintain the value.

At block 436, the image processing circuitry operates on the image data in the OPP color space. As discussed herein, the image processing circuitry may determine compensation, such as per-pixel gains, for the image data using one or more 1D LUTs. The image processing circuitry may apply the compensation to the source image data may boost pixel values to reduce or eliminate chromatic variations. Additionally or alternatively, operating in the OPP color space may provide a larger range of chromatic variations in comparison to the RGB color space. As such, applying chromatic corrections in the OPP color space may provide for image content with improved uniformity, color contrast, brightness, and/or saturation.

After operating on the image data, at block 438, the image processing circuitry converts the image data from the OPP color space back to the first color space. For example, the image processing circuitry may use one or more 3×3 transform matrices to convert the compensated image data from the OPP color space to the first color space. The 3×3 transform matrices may be an inverse of the 3×3 transform matrices used in block 434.

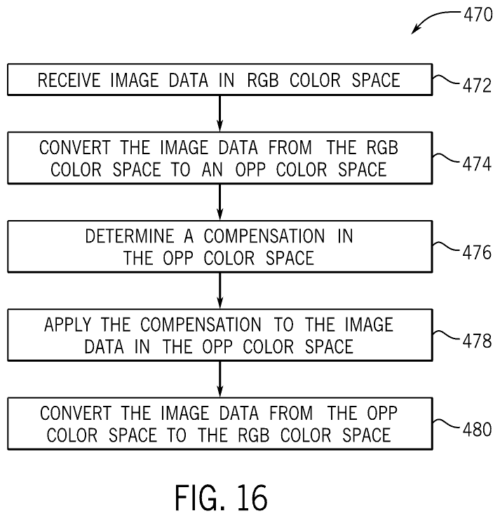

FIG. 16 is a flowchart of an example method 470 of the image processing circuitry determining and apply compensation to image data (e.g., source image data) to generate compensated image data in low-light conditions. While the method of FIG. 16 is described using process blocks in a specific sequence, it should be understood that the present disclosure contemplates that the described process blocks may be performed in different sequences than the sequence illustrated, and certain described process blocks may be skipped or not performed altogether.

At block 472, the image processing circuitry may receive image data in the RGB color space, similar to block 152 in FIG. 10 and block 432 described with respect to FIG. 15. At block 474, the image processing circuitry may convert the image data from the RGB color space to an OPP color space, similar to block 434 described with respect to FIG. 15.

At block 476, the image processing circuitry may determine a compensation in the OPP color space. For example, the image processing circuitry may determine per-pixel gains for each component of the pixel triplet based on one or more 1D LUT. Each of the 1D LUTs may be realized as a global curve as illustrated in FIGS. 13A-C. The strength of the global curve may be adjusted as a function of the L_{SDR-peak} parameter. For example, the L_{SDR-peak} parameter may be determined based on a weighting factor, an intended target panel display peak brightness in nits known at the input of chromatic correction, a panel EDR headroom factor known at the input of chromatic correction, and/or the activation threshold. The L_{SDR-peak} parameter may be used to compute tone and chroma compensation curve components. In a steady state, the first strength parameter 240A and the determination of L_{SDR-peak} parameter may correlate to an SDR brightness value which may be mapped to a commensurate compensation for tone curve and chromatic-correction components to reduce or eliminate perceived loss in low-light conditions. However, such correlation may depend on the type of electronic device 10, device constraints, product specifications, environmental factors, and the like.

At block 478, the image processing circuitry may apply the compensation to the image data in the OPP color space. The image processing circuitry may apply each per-pixel gain to the source image data to generate compensated image data.

At block 480, the image processing circuitry may convert the image data from the OPP color space to the RGB color space, similar to block 438 described with respect to FIG. 15.

In certain cases, chromatic corrections in bright-light conditions may be activated if the second strength parameter 240B is greater than zero. As discussed with respect to FIG. 11, the CCC block 204 may determine and apply compensation to the source image data 102 based on a 3D LUT in the bright-light conditions. For example, the CCC block 204 may receive the pixel triplet (c₀, c₁, c₂) in either a linear or gamma-encoded space. In certain instances, the CCC block 204 may apply a gain to the pixel triplet and output a boosted pixel triplet (c₀, c′₁, c′₂) with similar precision. That is, the CCC block 204 may pass through the c₀ component and apply a gain to the c₁, c₂ components.

With the foregoing in mind, FIG. 17 illustrates a schematic diagram of a 3D LUT 510 to provide a gain to boost pixel values. The 3D LUT 510 may include the range of RGB color values and provide for interpolation between one or more nodes 512 and extrapolation from the nodes (e.g., tap points) 512. The 3D LUT 510 may use all three pixel components to provide compensation for include memory colors, such as expected colors for the sky, the grass, and skin tone. That is, the memory colors may depend on a combination of a red component, a green component, and/or a blue component.

The 3D LUT 510 may be modulated based on the strength of each component and/or the ambient brightness value to provide for chromatic corrections. To this end, the 3D LUT 510 may include a first axis with multiple tap-points, a second axis with multiple tap-points, and a third axis with multiple-tap points. Each axis may correspond to a pixel component. For example, a first axis may correspond to the first pixel component, a second axis may correspond to the second pixel component, and the third axis may correspond to the third color component. In certain instances, the 3D LUT may receive the source image data 102 in the RGB color space. As such, the first axis may correspond to the red component, the second axis may correspond to the green component, and the third axis may correspond to the blue component. In other instances, the 3D LUT may receive the source image data 102 in the IPT color space. As such, the first axis may correspond to a luminance component, the second axis may correspond to a chrominance component, and the third color space may correspond to an additional chrominance component.

The tap-points of each axis may be adjustable (e.g., configurable, programmable) based on the strength of the component (e.g., the luminance component, the chrominance component) and/or a value of the component. Additionally or alternatively, the tap-points may be adjusted based on the strength parameter and/or the ambient brightness value. For example, areas of interest on each axis of the 3D LUT 510 may be determined based on the strength of each component of the pixel triplet. If the pixel component indicates a low saturation value, then the area of interest may correspond to a lower chrominance value and the tap-points may compress at the low chrominance value. If ambient brightness value indicates a high display brightness, then the area of interest may correspond to a higher chrominance value and tap-points may compress at a high chrominance value. The tap-points may be compressed in the areas of interest to fine-tune the compensation and the tap-points may be spread out in areas not of interest. In this way, a size of the 3D LUT may be reduced and storage efficiency may be improved. The compensation may be determined by interpolating between tap-points of each respective axis. As such, the 3D LUT 510 may be used as a proxy to realize complex gain functions intended for boosting pixel values. In other words, the 3D LUT 510 may model color gains based on ambient brightness values to reduce or eliminate chromatic deviations.

As illustrated, the 3D LUT 510 may be an 8×8×8 LUT with nodes 512 ranging from [0,7] in each dimension and bins 514. The 3D LUT 510 may be programmable based on the second strength parameter 240B. Additionally or alternatively, each of the nodes 512 may be unevenly spaced or evenly spaced. For example, a close-up view of the nodes 512 positioned on an edge 518 of the 3D LUT 510 illustrates uneven spacing between each of the nodes 512. As such, bins 514 of the 3D LUT 510 may be unevenly sized. The compensation may be determined based on four nodes 512 and the respective bin 514. For example, the 3D LUT 510 may receive the pixel triplet (c₀, c₁, c₂) in either a linear or a gamma-encoded space, such as IPT space. The 3D LUT 510 may use the c₁ component and the c₂ component to determine the four nodes 512. The 3D LUT 510 may support interpolation between the nodes 512 and/or extrapolation from the nodes 512. In this way, the compensation may be determined and the 3D LUT 510 may output a boosted pixel triplet (c′₀, c₁, c₂) of the same precision.

The 3D LUT 510 may include an additional node 516 for each dimension outside of the LUT 510. The additional node 516 may include a pre-determined constant value. The additional nodes 516 may be used for extrapolation to determine the HDR roll-off. In this way, the 3D LUT 510 may mimic a full 9×9×9 LUT with the exception that entries corresponding to the exterior grid plane may be controlled by a constant value.

It may be understood that the 8×8×8 LUT described herein is an illustrative example. The 3D LUT 510 may include any suitable number of nodes and/or bin indices, such as 2 or more, 3 or more, 4 or more, 5 or more, 6 or more, 7 or more, 9 or more, 10 or more, 11 or more, and so on. Indeed, spacing between the nodes 512 may be uneven or evenly spaced based on pixel component values, the image data, the ambient light conditions, and the like.

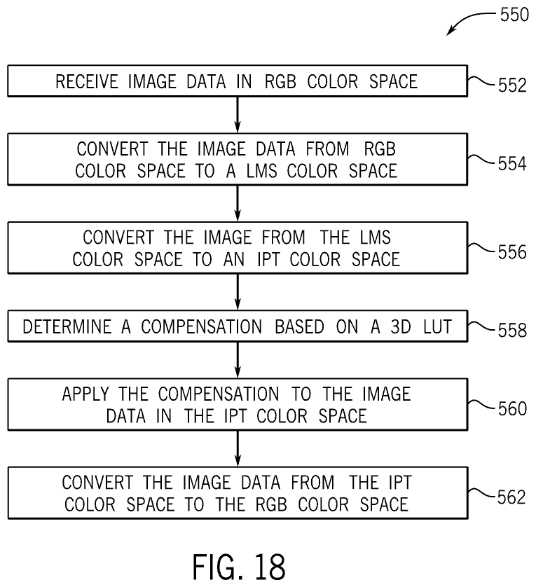

FIG. 18 illustrates a flowchart of an example method 550 of the image processing circuitry determining and applying compensation to image data to generate compensated image data in bright-light conditions. In certain cases, the image processing circuitry may implement the method 550 to determine and apply additional compensation to image data in low-light conditions. While the method of FIG. 18 is described using process blocks in a specific sequence, it should be understood that the present disclosure contemplates that the described process blocks may be performed in different sequences than the sequence illustrated, and certain described process blocks may be skipped or not performed altogether.

At block 552, the image processing circuitry receives image data in the RGB color space, similar to block 472 described with respect to FIG. 16. At block 554, the image processing circuitry converts the image data from the RGB color space to the LMS color space. For example, the conversion may use a 3×3 transform matrix, such as a linear RGB to LMS matrix, to convert pixel values from the RGB color space to the LMS color space. Depending on a degree of white-point and viewing condition adaptation, the 3×3 transform matrix may intake chromatic adaptation from reference light conditions. To this end, the 3×3 transform matrix may use cross-talk coefficients, an XYZ to LMS matrix, a chromatic adaptation matrix, an LMS white point, an adaptation factor, a degree of chromatic adaption, a cone response of target white point, and/or a target white point. For example, the LMS white point may be a view corrected LMS D65 white point with three parameters. In another example, the degree of chromatic adaptation may be set to 1.0. Still in another example, the target white point may be set to a standard P3 gamut D65. In an embodiment, the cross-talk coefficients may be set to 1.0 for the IPT color space.

At block 556, the image processing circuitry converts the image data from the LMS domain to the IPT color space. For example, the conversion may use a 3×3 transform matrix to convert gamma domain LMS (D65 white) to the IPT color space. The 3×3 transform matrix may include nine coefficients.

At block 558, the image processing circuitry determines a compensation based on a 3D LUT. As discussed with respect to FIG. 17, the 3D LUT may intake a pixel triplet to determine four nodes and a bin. The 3D LUT may support interpolation between the nodes and/or extrapolation from the nodes to determine the compensation.

At block 560, the image processing circuitry may apply the compensation to the image data in the IPT color space. The 3D LUT may apply the compensation and output a boosted pixel triplet (c₀, c′₁, c′₂). As discussed herein, the 3D LUT may pass through the c₀ component while multiplying, rounding, and/or clipping the c′₁ and c′₂ components.

At block 562, the image processing circuitry may convert the image data from the IPT color space to the RGB color space. For example, one or more 3×3 transform matrices may be used to convert the compensated image data from the IPT color space back to the RGB color space. For example, the one or more 3×3 transform matrices may be set to LMS D65 to RGB, which may be an inverse of the 3×3 transform matrices described in blocks 554 and 556. Additionally or alternatively, the compensated image data may be transmitted to other processing blocks and/or the display panel 106. The compensated image data may be used to drive the display pixels such that the image content is displayed with reduced or eliminated chromatic deviations due to ambient dependent color perception.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. An electronic device comprising image processing circuitry, the image processing circuitry configured to:
convert image data from a first color space to an opponent (OPP) color space;
adjust the image data in the OPP color space; and
convert the image data from the OPP color space to the first color space.

2. The electronic device of claim 1, wherein the image processing circuitry is configured to adjust the image data in the OPP color space based at least in part on one or more one-dimensional lookup tables.

3. The electronic device of claim 2, wherein the one or more one-dimensional lookup tables comprise a boundary and a two-piece function, wherein the two-piece function comprises:
a first function of the two-piece function comprises a constant value; and
a second function of the two-piece function comprises a Q-th order polynomial.

4. The electronic device of claim 3, wherein the image processing circuitry is configured to:
adjust the image data based at least in part on the first function in response to operating in a standard definition range; or
adjust the image data based at least in part on the second function in response to operating in a high definition range.

5. The electronic device of claim 3, wherein the image processing circuitry is configured to:
identify a pixel triplet of the image data; and
adjust the image data based at least in part on a first component of the pixel triplet and the two-piece function.

6. The electronic device of claim 1, wherein the image processing circuitry is configured to adjust the image data in the OPP color space at least in part by:
identifying a pixel triplet corresponding to a luminance component of the image data and a chrominance component of the image data in the OPP color space; and
increasing the luminance component in response to determining the chrominance component is fully saturated.

7. The electronic device of claim 1, wherein the image processing circuitry is configured to prepare the image data for display on an electronic display in response to determining an ambient brightness level being less than a threshold.

8. The electronic device of claim 7, wherein the image processing circuitry is configured to adjust the image data in response to determining the threshold is 100 nits.

9. The electronic device of claim 1, wherein the image processing circuitry is configured to adjust the image data by:
receiving an ambient brightness value and an intended brightness value;
determining a strength parameter corresponding to a strength of adjustment to the image data based at least in part on the ambient brightness value, the intended brightness value, and a two-dimensional lookup table; and
determining the adjustment based at least in part on one or more one-dimensional lookup tables based in part on the strength parameter being greater than zero.

10. An electronic device comprising image processing circuitry, the image processing circuitry is configured to:
in response to determining an ambient light level is greater than a threshold:
convert image data from a first color space to an image processing transform (IPT) color space;
increase a saturation of the image data in the IPT color space; and
convert the image data from the IPT color space to the first color space.

11. The electronic device of claim 10, wherein the image processing circuitry is configured to increase the saturation of the image data in the IPT color space at least in part by:
receiving an intended display brightness value of an electronic display; and
determining a strength parameter based at least part on a two-dimensional lookup table, the ambient light level and the intended display brightness value.

12. The electronic device of claim 11, wherein the threshold is 5000 lux.

13. The electronic device of claim 10, wherein the image processing circuitry is configured to increase the saturation of the image data at least in part by:
adjusting respective positions of one or more tap-points of a three-dimensional lookup table based at least in part on a strength parameter corresponding to a strength for adjusting the image data.

14. The electronic device of claim 13, wherein the three-dimensional lookup table comprises a plurality of nodes, and wherein the image processing circuitry is configured to increase the saturation the image data at least in part by:
interpolating between a first tap-point of the one or more tap-points and a second tap-point of the one or more tap-points for an image data pixel gain; or
extrapolating from the first tap-point, the second tap-point, or both for the image data pixel gain.

15. The electronic device of claim 10, wherein the image processing circuitry is configured to convert the image data from the first color space to the IPT color space based at least in part on one or more 3×3 transform matrices.

16. The electronic device of claim 10, wherein the image processing circuitry is configured to convert the image data from the IPT color space to the first color space based at least in part on one or more inverse 3×3 transform matrices.

17. Processing circuitry configured to:
receive image data for display on an electronic display;
adjust the image data using a three-dimensional lookup table comprising:
adjusting a first axis of the three-dimensional lookup table, the first axis comprising a first plurality of tap-points based on a strength parameter corresponding to compensation to apply to image data; and
adjusting a second axis of the three-dimensional lookup table, the second axis comprising a second plurality of tap-points based on the strength parameter.

18. The processing circuitry of claim 17, wherein the three-dimensional lookup table comprises a third axis comprising a third plurality of tap-points configurable to be adjusted based on the strength parameter.

19. The processing circuitry of claim 18, wherein the three-dimensional lookup table comprises a fourth plurality of tap-points comprising a respective constant value, wherein each of the fourth plurality of tap-points is positioned adjacent to the first axis, the second axis, or the third axis.

20. The processing circuitry of claim 17, wherein the three-dimensional lookup table comprises:
a first spacing of the first plurality of tap-points along the first axis configurable based at least in part on the strength parameter; and
a second spacing of the second plurality of tap-points configurable based at least in part on the strength parameter.

21. The processing circuitry of claim 20, wherein the first spacing and the second spacing are uneven.

22. The processing circuitry of claim 21, wherein the strength parameter is determined based on an ambient brightness value from a sensor coupled to the processing circuitry and an intended brightness value corresponding to a target luminance of the image data received by the processing circuitry.

23. Processing circuitry, comprising:
first conversion circuitry configured to convert image data corresponding to a display pixel of an electronic display from a first color space to an opponent (OPP) color space;
chromatic correction circuitry configured to adjust the image data in the OPP color space; and
second conversion circuitry configured to convert the image data from the OPP color space to the first color space.

24. The processing circuitry of claim 23, wherein the first conversion circuitry is configured to convert the image data from the first color space to the OPP color space based at least in part on a 3×3 transform matrix.

25. The processing circuitry of claim 23, wherein the chromatic correction circuitry is configured to adjust the image data based at least in part by:
receiving an ambient brightness value from a sensor;
determining an intended brightness value based on the image data; and
determining a strength parameter based at least in part on the ambient brightness value, the intended brightness value, and a first two-dimensional lookup table.

26. The processing circuitry of claim 25, when the strength parameter is greater than zero, the chromatic correction circuitry is configured to adjust the image data at least in part by:
determining a first gain value for a first component of the image data based at least in part on a first one-dimensional lookup table;
determining a second gain value for a second component of the image data based at least in part on a second one-dimensional lookup table; and
determining a third gain value for a third component of the image data based at least in part on a third one-dimensional lookup table.

27. The processing circuitry of claim 25, wherein the chromatic correction circuitry is configured not to adjust the image data in response to the strength parameter being less than zero.

28. Processing circuitry, comprising:
first conversion circuitry configured to convert image data corresponding to a display pixel of a plurality of display pixels of an electronic display from a first color space to an image processing transform (IPT) color space in response to determining an ambient light level being greater than a threshold;
chromatic correction circuitry configured to adjust the image data in the IPT color space by increasing a saturation of the image data; and
second conversion circuitry configured to convert the image data from the IPT color space to the first color space.

29. The processing circuitry of claim 28, wherein the chromatic correction circuitry is configured to adjust the image data based at least in part on a three-dimensional look up table comprising a plurality of tap-points, wherein the chromatic correction circuitry is configured to:
adjust a first set of tap-points of the plurality of tap-points based at least in part on a strength parameter;
interpolate between a first tap-point of the first set of tap-points and a second tap-point of the first set of tap-points corresponding to an image pixel gain; and
apply the image pixel gain to the image data.
